(19) United States
(12) Patent Application Publication
(10) Pub. No.: US 2023/0410096 A1
(43) Pub. Date: Dec. 21, 2023

(54) A SYSTEM AND METHOD FOR ARTIFICIAL INTELLIGENCE-BASED DIGITAL CREDIT MODULE AND PERSONALIZED ASSISTANCE

(71) Applicants: Vishal MISHRA, Noida (IN); Shefali BOHIDAR, Sambalpur (IN)

(72) Inventors: Vishal MISHRA, Noida (IN); Shefali BOHIDAR, Sambalpur (IN)

(21) Appl. No.: 18/036,483

(22) PCT Filed: Nov. 10, 2021
(86) PCT No.: PCT/IN2021/051061

§ 371 Date: May 11, 2023

(30) Foreign Application Priority Data
Nov. 12, 2020 (IN) 202011049576

(51) Int. Cl. G06Q 20/38; G06Q 20/24; G06Q 40/02

(52) U.S. Cl. CPC G06Q 20/3821; G06Q 20/24; G06Q 40/02

(57) ABSTRACT

The present invention relates to a system(100) and a method for artificial intelligence-based digital credit module and personalized assistance. The system(100) of the present invention includes an analytic database(108), a universal database(118), a main server computer(102), a member-computing device(110), a merchant computing device(122), a warehouse database(114), an unstructured database(116), a payment gateway server(120). The main server computer(102) further includes a server computer memory(104) and a system processing unit(106). The system processing unit(106) is connected to the analytic database(108), a member-computing device(110), a merchant computing device(122), a warehouse database(114), an unstructured database(116), a payment gateway server (120) and the universal database(114). The system processing unit(106) executes server-computer-readable instructions to automatically managing payments through the digital credit module and performing a plurality of personalized assistance tasks with the help of an artificial intelligence-based personalized assistance model.

### FIELD OF INVENTION

The present invention relates to a system and method for digital credit module payment management and more specifically present invention relates to a system and method for artificial intelligence-based digital credit module and personalized assistance.

### BACKGROUND OF THE INVENTION

Money transaction is an important part of the economy because traders and consumers in different places transact money with each other to run their economy. Obviously to run and grow the economy people should have money in their hands or we can say in their bank account. The government put money in the bank through bonds; and banks further give money to other entities through loans. Then the entity generates goods and services that are being purchased by people and people also get money from loan and salary this being given by the entity, which took money through a loan. Earlier transactions are made using cash that is a piece of paper. Now, people through digital means transact good fractions of money in the market. People make the transaction through online banking; electronics debit cards, credit cards, and UPI. With digitization, there is also the problem of security. People may lose their debit cards and credit card and can be used by others. Also, in the case of credit cards, it is difficult to maintain repayment of the credit and manage EMI. It also becomes difficult for people to manage their money and use it efficiently.

KR20130101778A discloses PURPOSE: A smartphone-using credit card payment system and a method thereof minimizes credit card-related risks both for an individual and the general public by saving pieces of important information for a payment process both in a smartphone and a server and assembling them when the original information is required for a payment to be settled. CONSTITUTION: A buyer installs a wallet application on his/her smartphone. A seller installs a membership store application in a membership store device (s10). Using the wallet application, the buyer registers information about his/her credit card with an assigned server (s20) and sets his/her favorite membership store (s30). The buyer decides to purchase a certain product (s40). An application server requests a card company to approve the buyer's credit card payment for the product and transmits the card company's approval to the membership store application and the buyer's wallet application (s50). [Reference numerals] (AA) Start; (BB) End; (S10) Install a wallet application and a membership store application; (S20) Register a credit card; (S30) Wait for a payment; (S40) Confirm that a transaction has been finalized; (S50) Request for approval and receive the results; (S60) Transmit and receive a signature.

In the prior art, the existing invention does not generate a digital credit module though they are using a physical credit card to perform an online transaction. The existing inventions are unable to provide payment management assistance. The existing invention incurs a loss to the user in managing their repayment. The present invention is capable of overcoming all drawbacks of the existing inventions hence there is a need for the present invention.

### OBJECTIVE OF THE INVENTION

The main objective of the present invention is to provide a digital credit module without a plastic card substance.

Another objective of the present invention is to develop a system that helps transactions and credit card payments without actually carrying a physical credit card.

Yet another objective of the present invention is to develop a digital credit module that automatically makes repayment and purchases essential.

Yet another objective of the present invention is to develop a system that also provides personalized finance assistance along with a digital credit module service.

Yet another objective of the present invention is to develop a system for offline payment between merchant and member.

Further objectives, advantages, and features of the present invention will become apparent from the detailed description provided herein below, in which various embodiments of the disclosed invention are illustrated by way of example.

### SUMMARY OF THE PRESENT INVENTION

The present invention relates to a system and method for artificial intelligence-based digital credit module and personalized assistance. The system of the present invention includes an analytic database, a universal database, a main server computer, a member-computing device, a merchant computing device, a warehouse database, an unstructured database, a payment gateway server. The analytic database stores artificial intelligence-based personal assistance models and data for training artificial intelligence-based personal assistance models. The universal database stores the credentials of a member and merchant, and as well as other data related to banks, finance, transactions ID, offline payment details and digital credit module. The main server computer further includes a server computer memory and a system processing unit. The server computer memory stores server computer-readable instructions and credentials of a member as well as other data related to banks, finance, transactions and digital credit module. The system processing unit is connected to the analytic database and the universal database. Herein the system processing unit executes server-computer-readable instructions to train an artificial intelligence-based personalized assistance model and further executes server computer-readable instructions to automatically managing payments through the digital credit module and performing a plurality of personalized assistance tasks with the help of artificial intelligence-based personalized assistance model. Herein, the system processing unit executes server-computer-readable instructions to manage the credentials of a member as well as other data related to banks, finance, and digital credit module. The member-computing device is connected to the system processing unit of the main server computer through a public network communication server. The member-computing device executes member computer-readable instructions to communicate with the system processing unit to perform a digital credit module based payment and a plurality of personalized assistance tasks. The member-computing device includes a display unit and a member database. The display unit displays all the data that is being communicated to the member-computing device through the system processing unit of the main server computer. The member database stores credentials of a member as well as other data related to banks, finance, transactions ID, offline payment details and a digital credit module. Herein, the display unit of the member-computing device is the interface between the system processing unit and the member. The merchant computing device is connected to the system processing unit of the main server computer through a public network communication server. The merchant computing device executes merchant computer-readable instructions to communicate with the system processing unit to receive payment and purchase orders from the member-computing device through the digital credit module. The merchant computing device include a merchant database. The merchant database stores credentials of a merchant as well as other data related to banks, finance, transactions ID, offline payment details and invoices. The warehouse database is connected to the system processing unit of the main server computer. The unstructured database is connected to the system processing unit of the main server computer. The payment gateway server is connected to the system processing unit of the main server computer and the universal database, the payment gateway server performs payment and invoice transfer between the merchant computing device and the member-computing device. In an embodiment, the data for training the artificial intelligence-based personal assistance models are extracted from the universal database and the member-computing device. In an embodiment, herein, the member-computing device processor performs the automated purchase of goods and services with the help of a trained artificial intelligence-based personal assistance model that learns from the purchase pattern of the member and various other online activities of member.

The main advantage of the present invention is that the present invention is able to provide a digital credit module payment service that does not require the physical credit card.

Another advantage of the present invention is that the present invention automatically makes payment through the digital credit module, user only just needs to confirm once.

Yet another advantage of the present invention is that the present invention is able to assists users to make purchase decisions.

Yet another advantage of the present invention is that the present invention uses machine learning and learns from user payment activity and thus provides personalized assistance to the user.

Yet another advantage of the present invention is that the present invention uses machine learning that learns from the user's lifestyle and eating habits, further suggest healthy foods and a healthy lifestyle.

Yet another advantage of the present invention is that the present invention updates user on important dates, events, meetings, anniversary, further accordingly makes a purchase, books tickets, book cabs, etc.

Yet another advantage of the present invention is that the present invention reminds the user for purchasing essential for home and further automatically purchase essentials once the user confirms.

Yet another advantage of the present invention is that the present invention is able to assists users to make payment without internet connection that is assisting in offline payment.

Further objectives, advantages, and features of the present invention will become apparent from the detailed description provided herein below, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates the block diagram of the present invention

FIG. 2 illustrates a flow chart for the method of member sign up.

FIG. 3 illustrates a flow chart for the method of member digital credit module registration.

FIG. 4 illustrates a flow chart for the method of creating artificial intelligence-based personal assistance models.

FIG. 5 illustrates a flow chart for the method of purchasing essentials using digital credit module.

FIG. 6 illustrates a flow chart for the method of the on-spot purchasing assistant.

FIG. 7 illustrates flow chart for a method of offline transaction between member and merchant.

FIG. 8 illustrates a method of offline payment details synchronization with online payment data.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definition

The terms “a” or “an”, as used herein, are defined as one or as more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”. Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation. The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein, the term “one or more” generally refers to, but is not limited to, singular as well as the plural form of the term.

The drawings featured in the figures are for the purpose of illustrating certain convenient embodiments of the present invention and are not to be considered as limitation thereto. The term “means” preceding a present participle of an operation indicates the desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

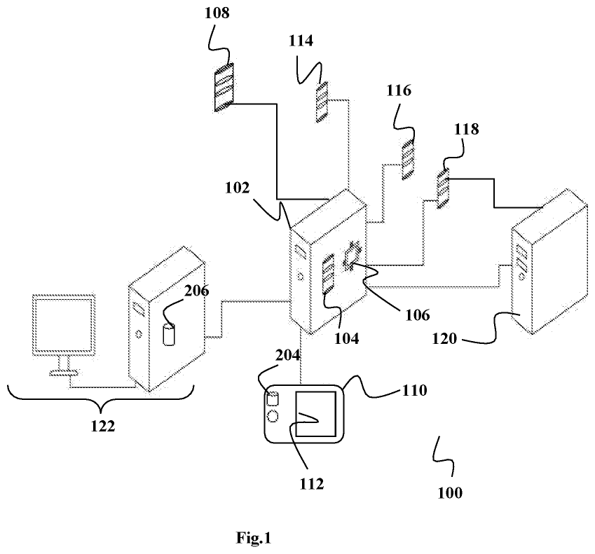

FIG. 1 illustrates the block diagram of the system(100) of the present invention. The system(100) of the present invention includes an analytic database(108), a universal database(118), the main server computer(102), a member-computing device(110), a merchant computing device(122), a warehouse database(114), an unstructured database(116), and a payment gateway server(120). The main server computer(102) further includes a server computer memory(104) and a system processing unit(106). The system processing unit(106) is connected to the analytic database(108) and the universal database(114). The member-computing device(110) is connected to the system processing unit(106) of the main server computer(102). The member-computing device(110) includes a display unit(112). The merchant computing device(122) is connected to the system processing unit(106) of the main server computer(102). The warehouse database (114) is connected to the system processing unit(106) of the system processing unit(106) of the main server computer(102). The unstructured database(116) is connected to the system processing unit(106) of the system processing unit(106) of the main server computer(102). The payment gateway server(120) is connected to the system processing unit(106) of the system processing unit(106) of the main server computer(102) and the universal database(118).

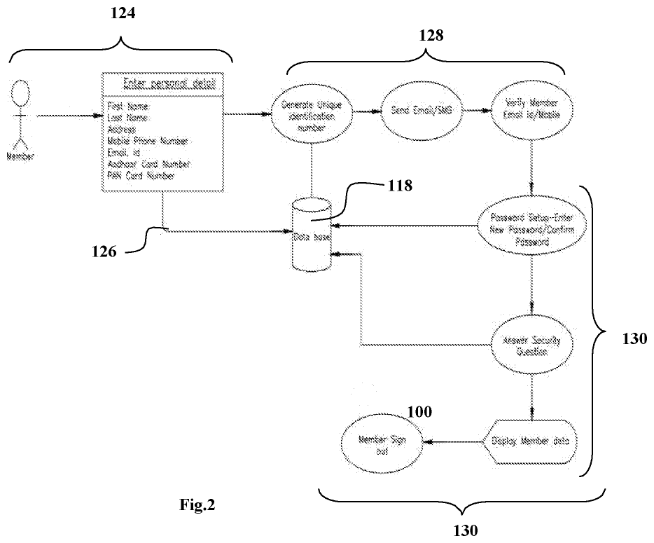

FIG. 2 illustrates a flow chart for the method of member sign up. In Step (124), a member communicates personal information to the main server computer(102) by using a member-computing device(110). In Step (126), a system processing unit(106) of the main server computer(102) stores the personal information into a universal database(118). In Step (128), further, the system processing unit(106) generates unique ID and sends the unique ID to member the member-computing device(110) to set up a password and security question. In Step (130), further, all password and security questions are displayed on a display unit(112) of the member-computing device(110) and stored in the universal database(118).

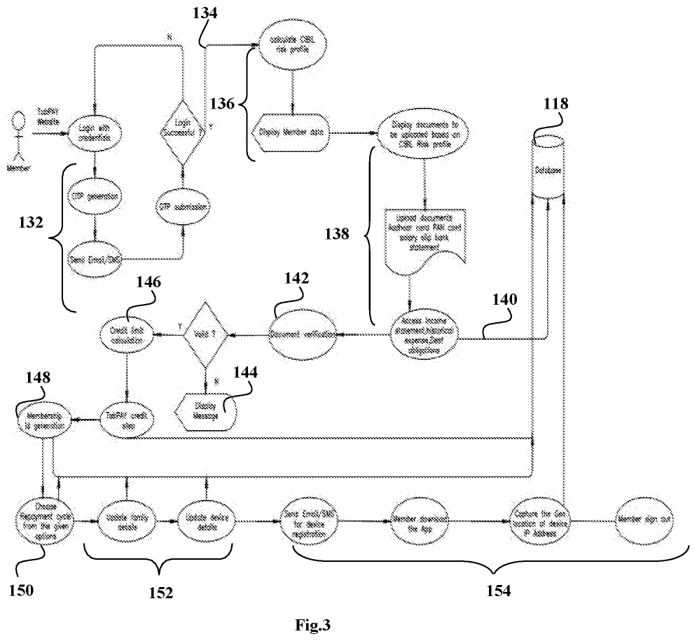

FIG. 3 illustrates a flow chart for the method of member digital credit module registration. In Step (132), the member communicates password and OTP to the main server computer(102) by using the member-computing device(110). In Step (134), the system processing unit(106) allows the member to log in to the main server computer(102). In Step (136), the system processing unit(106) executes server computer-readable instructions to calculate the credit risk of the member and display credit risk on the display unit(112). In Step (138), the system processing unit(106) executes server computer-readable instructions to display documents to be uploaded on the universal database(118) based on credit risk. In Step (140), the system processing unit(106) executes server computer-readable instructions to store, personal identification details in an encrypted form and all the documents, into the universal database(118). In Step (142), the system processing unit(106) executes server computer-readable instructions and verifies the Member Income, spending behaviour, transactions, debts, repayment history, and credit risk profile. In Step (144), in case of missing information, a message is displayed on the display unit(112). In Step (146), in case, documents verification is successful, using the prebuilt logic, the system processing unit(106) calculates the member credit limit and stores in the universal database(118). In Step (148), the system processing unit(106) generates the membership ID if the credit limit is greater than zero. In Step (150), with the help of the member-computing device(110), the member selects the Repayment cycle, and the same is stored in the universal database(118). In Step (152), the member updates family member details and the member-computing device(110) details, the same is stored in the universal database(118). In Step (154), the system processing unit(106) generates an Email/SMS with the link to download the artificial intelligence-based digital credit module on the member-computing device(110). Thus, a member now uses an artificial intelligence-based digital credit module to purchase goods and services.

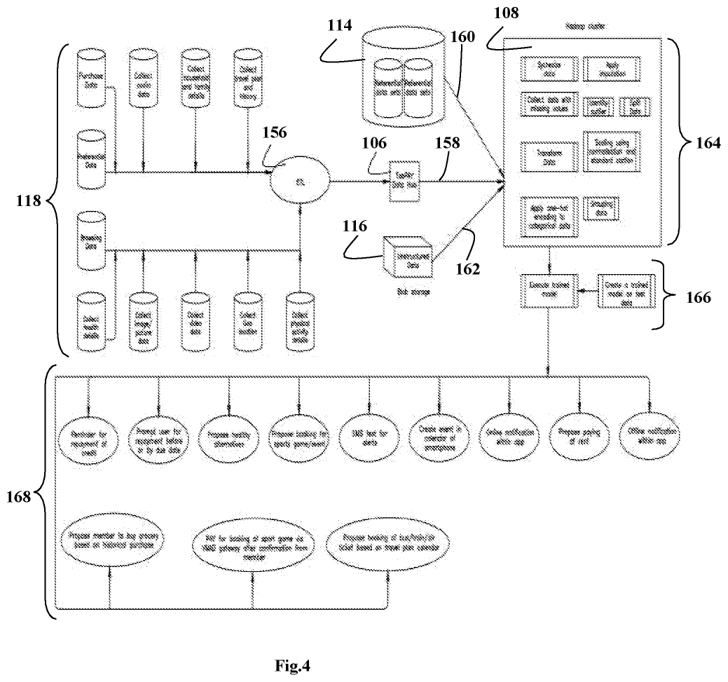

FIG. 4 illustrates a flow chart for the method of creating an artificial intelligence-based personal assistance model. In Step (156), the system processing unit(106) retrieve all type of information about the member from the universal database(118), the member-computing device(110) through the extract, transform and load method. In Step (158), the system processing unit(106) stores all types of retrieved information into the analytic database(108). In Step (160), the system processing unit(106) stores the referential dataset into the warehouse database (114). In Step (162), the system processing unit(106) stores unstructured data from the member-computing device(110) into an unstructured database(116). In Step (164), the system processing unit(106) takes all the data from an analytic database(108), a warehouse database (114), and an unstructured database(116) and further, the system processing unit(106) executes server computer-readable instructions to synthesize data, find data with missing values and apply imputation on data with missing values. The system processing unit(106) executes server computer-readable instructions to identify outlier data and removed the same. The system processing unit(106) executes server computer-readable instructions to categorized data on the different categories. The system processing unit(106) executes server computer-readable instructions to apply encoding to categorical data. The system processing unit(106) executes server computer-readable instructions to scale data using normalization and standardization. In Step (166), the system processing unit(106) further feed data into the artificial intelligence-based personal assistance models and train the artificial intelligence-based personal assistance models. In Step (168), Herein, the artificial intelligence-based personal assistance models are being used by the system processing unit(106) to automatically send timely alerts, notification, digital credit module information, and provides personal assistance to member based on learning from members purchasing behaviour and other activities.

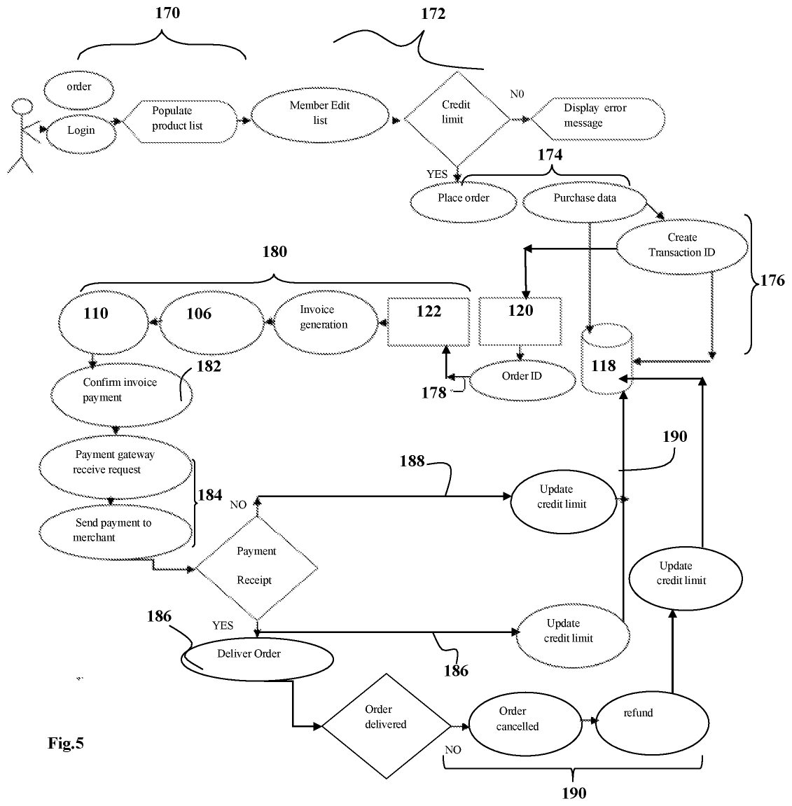

FIG. 5 illustrates a flow chart for the method of purchasing essentials using the digital credit module and the artificial intelligence-based personal assistance models. In Step (170), based on purchasing pattern and consumption rate the artificial intelligence-based personal assistance models populate a list of items on the display unit(112) of the member-computing device(110). In Step (172), the member edits the list and confirms the items to be purchased, the artificial intelligence-based personal assistance models check the credit limit of the digital credit module. In Step (174), in case, the credit is available then the artificial intelligence-based personal assistance models direct to place an order and store the purchase data in the universal database(118). In Step (176), the artificial intelligence-based personal assistance models create transaction ID and send transaction ID to a payment gateway server(120) and stores the creates transaction ID in the universal database(118). In Step (178), a payment gateway server(120) generates an order ID and sends the order ID to the merchant on a merchant computing device(122). In Step (180), the merchant generates an invoice on the merchant computing device(122) and sends the invoice to the system processing unit(106) that is further sent to the member-computing device(110). In Step (182), the member checks the invoice and confirms, then artificial intelligence-based personal assistance models initiate payment through the digital credit module. In Step (184), the payment gateway server(120) received a payment request and the payment gateway server(120) sends payment to the merchant account. In Step (186), on receiving payment merchant delivers the order. In Step (188), in case the payment is not received by the merchant then the artificial intelligence-based personal assistance models update the credit limit in the universal database(118). In Step (190), in another case, an order is canceled and the payment gateway server(120) makes a refund then the artificial intelligence-based personal assistance models update the credit limit in the universal database(118).

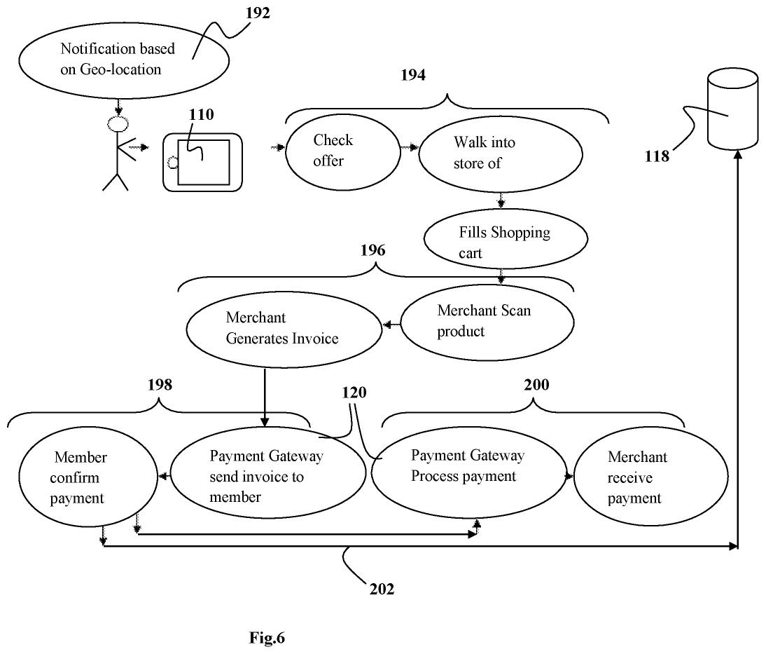

FIG. 6 illustrates a flow chart for the method of on-spot purchasing assistant. In Step (192), the artificial intelligence-based personal assistance model sends a notification to a member on the member-computing device(110), based on member preferences and geo-location. In the preferred embodiment, the artificial intelligence-based personal assistance model sends a notification to the member, when the member is in a shopping mall and arcade, and when the member is in particular store. In Step (194), the member enters the store based on offers notification received on the member-computing device(110) and member select items and go to the counter for billing and payment. In Step (196), the merchant generates the invoice and sends the invoice to the member-computing device(110) through the payment gateway server(120). In Step (198), the member confirms the invoice, the artificial intelligence-based personal assistance models check the credit limit of the digital credit module. In case, the credit is available then the artificial intelligence-based personal assistance models to proceed for payment. The member initiates payment through digital credit module. In Step (200), the payment gateway server(120) received a payment request and the payment gateway server(120) sends payment to the merchant account. On receiving payment merchant delivers the order. In Step (202), once payment is received by the merchant then the artificial intelligence-based personal assistance models update the credit limit in the universal database(118).

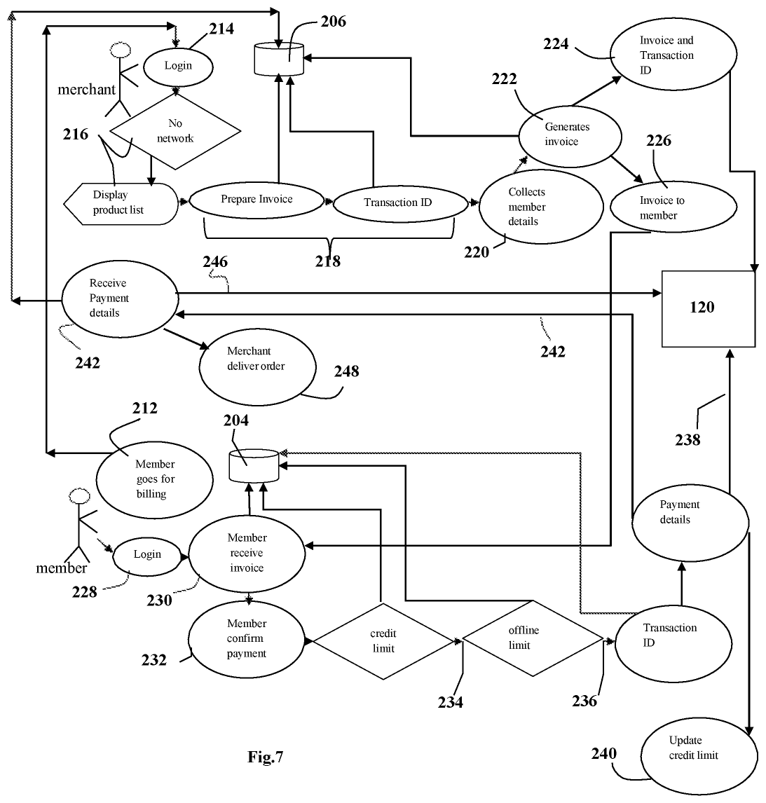

FIG. 7 illustrates flow chart for a method of offline transaction between member and merchant. In step(212), the member completes the shopping and goes to counter for billing and payment. In step(214), the merchant logged into the merchant computing device(122). In step(216), in case, there is no network, then the merchant computing device(122) display product list and price that is stored in the merchant database(206). In step(218), the merchant prepares offline invoice and then the merchant computing device(122) generates the transaction ID that are stored in in the merchant database(206). In step(220), the merchant computing device(122) collects the Member details from the member computing device(110) through merchant wireless unit(208). In step(222), then the merchant computing device(122) generates offline invoice. In step(224), then the merchant computing device(122) sends the offline invoice to the member computing device(110) with help of a merchant wireless unit(208). In step(226), the merchant computing device(122) also sends transaction ID and offline invoice details to a payment gateway server(120) through the merchant wireless unit(208). In step(228), the member logged into the member computing device(110). In step(230), the offline invoice details are received by the member computing device(110) through a member wireless unit(210), then, the member computing device(110) stores offline invoice detail in a member database(204). In step(232), member confirm payment of offline invoice through the member computing device(110). In step(234), in case, the credit limit is less than offline invoice amount then the member computing device(110) check if the invoice amount less than the offline payment limit and update same on member database(204). In step(236), in case, invoice amount less than the offline payment limit then the member computing device(110) generates transaction ID that is stored in the member database(204). In step(238), then the member computing device(110) sends the offline payment details to payment gateway server(120) through member wireless unit(210). In step(240), then the member computing device(110) updates the credit limit and offline payment limit and stores in the member database(204). In step(242), simultaneously, the member computing device(110) sends the offline payment details to the merchant computing device(122) through the member wireless unit(210). In step(244), then again the merchant computing device(122) update offline payment details against the offline invoice and sends updates of the offline payment received details to payment gateway server(120) through the merchant wireless unit(208). In step(246), the payment gateway server(120) received the offline payment received details and stored the same. In step(248), on receiving payment merchant delivers the order.

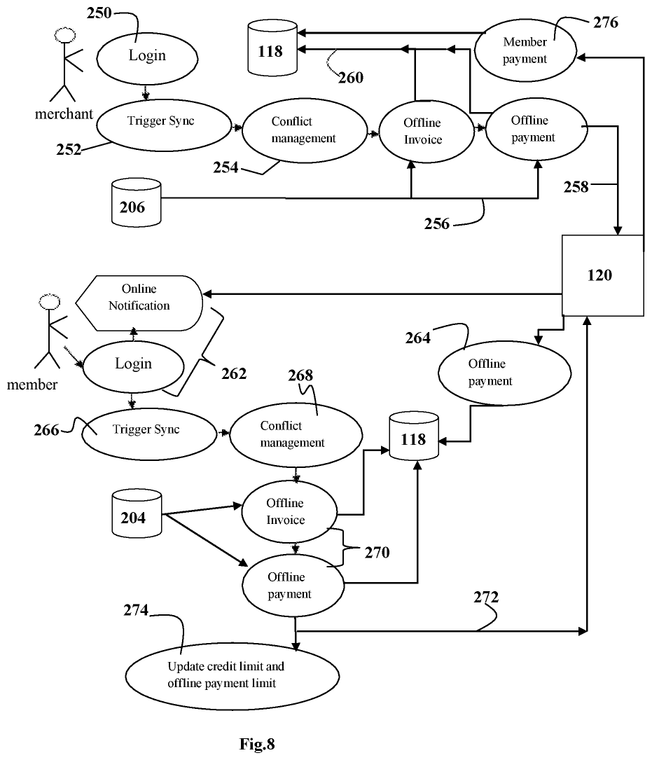

FIG. 8 illustrates a method of offline payment details synchronization with online payment data. In step(250), the merchant logged into the merchant computing device(122) and check if the merchant computing device(122) gets online and connected to an universal database(118). In step(252), when the merchant computing device(122) gets online, then triggers to synchronize offline transactions. In step(254), if there is any conflict with online transactions, the merchant computing device(122) decides which transactions will have priority based on the defined conflict rules. In step(256), the merchant computing device(122) extract the offline invoices details and offline payment details from the merchant database(206). In step(258), then the merchant computing device(122) generates the detailed offline invoice and offline payment details and sends to the payment gateway server(120). In step(260), the merchant computing device(122) also sends, the detailed offline invoice and offline payment details, to the universal database(118) to be stored in the universal database(118). In step(262), when member logged into the member computing device(110) then gets notification from the payment gateway server(120) to synchronize offline transactions. In step(264), the payment gateway server(120) sends the detailed offline invoice to the universal database(118) that is accessed by the member computing device(110). In step(266), the member computing device(110) synchronizes the offline payment and offline invoice details. In step(268), if there is any conflict with online transactions, the member computing device(110) decides which transactions will have priority based on the defined conflict rules. In step(270), the member computing device(110) again extracts the offline invoices and offline payment details that is stored in the member database(204) and sends to be stored in the universal database(118). In step(272), and the member computing device(110) sends synchronized offline payment and offline invoice details to the payment gateway server(120) from the member database(204). In step(274), a system processing unit(106) update the credit limit and offline payment limit in the universal database(118). In step(276), simultaneously, the payment gateway server(120) executes online payment and sends payment details to the merchant computing device(122) and the merchant computing device(122) update payment receiving details in the universal database(118) and the merchant database(206).

The present invention relates to a system and method for artificial intelligence-based digital credit module and personalized assistance. The system of the present invention includes an analytic database, a universal database, the main server computer, a member-computing device, a merchant computing device, a warehouse database, an unstructured database, a payment gateway server. The analytic database stores artificial intelligence-based personal assistance models and data for training artificial intelligence-based personal assistance models. The universal database stores the credentials of a member and merchant, and as well as other data related to banks, finance, transactions ID, offline payment details and a digital credit module. The main server computer further includes a server computer memory and a system processing unit. The server computer memory stores server computer-readable instructions. The system processing unit is connected to the analytic database and the universal database. Herein the system processing unit executes server-computer-readable instructions to train an artificial intelligence-based personalized assistance model and further executes server computer-readable instructions to automatically managing payments through the digital credit module and performing a plurality of personalized assistance tasks with the help of artificial intelligence-based personalized assistance model. Herein, the system processing unit executes server-computer-readable instructions to manage the credentials of a member as well as other data related to banks, finance, merchants and digital credit module. The member-computing device is connected to the system processing unit of the main server computer through a public network communication server. The member-computing device executes member computer-readable instructions to communicate with the system processing unit to perform a digital credit module based payment and a plurality of personalized assistance tasks. The member-computing device includes a display unit and a member database. The display unit displays all the data that is being communicated to the member-computing device through the system processing unit of the main server computer. The member database stores credentials of a member as well as other data related to banks, finance, transactions ID, offline payment details and a digital credit module. Herein, the display unit of the member-computing device is the interface between the system processing unit and the member. The merchant computing device is connected to the system processing unit of the main server computer through a public network communication server. The merchant computing device executes merchant computer-readable instructions to communicate with the system processing unit to receive payment and purchase orders from the member-computing device through the digital credit module. The merchant computing device include a merchant database. The merchant database stores credentials of a merchant as well as other data related to banks, finance, transactions ID, offline payment details and invoices. The warehouse database is connected to the system processing unit of the main server computer. The unstructured database is connected to the system processing unit of the main server computer. The payment gateway server is connected to the system processing unit of the main server computer and the universal database, the payment gateway server performs payment and invoice transfer between the merchant computing device and the member-computing device. In an embodiment, the member-computing device and the merchant computing device include, but are not limited to, a desktop computer, a laptop, a tab, a smartphone, and a smart watch. In an embodiment, the data for training the artificial intelligence-based personal assistance model are extracted from the universal database and the member-computing device. In an embodiment, herein, the member-computing device processor performs the automated purchase of goods and services with the help of a trained artificial intelligence-based personal assistance model that learns from the purchase pattern of the member and various other online activities of member. In an embodiment, herein, artificial intelligence-based personal assistance models is a machine-learning model. In an embodiment, for offline payment transaction between the member computing device and the merchant computing device use the merchant wireless unit and member wireless unit that are selected from Near Filed Communication device, Unstructured Supplementary Service Data system, and Bluetooth

In an embodiment, the present invention relates to a system and method for artificial intelligence-based digital credit module and personalized assistance. The system of the present invention includes one or more analytic databases, one or more universal databases, one or more main server computers, member-computing device, one or more merchant computing devices, a warehouse database, an unstructured database, a payment gateway server. The one or more analytic databases store artificial intelligence-based personal assistance models and data for training an artificial intelligence-based personal assistance model. The one or more universal databases store the credentials of a member and merchant, and as well as other data related to banks, finance, transactions ID, offline payment details and a digital credit module. The one or more main server computers further include one or more server computer memories and a system processing unit. The one or more server computer memories store server computer-readable instructions and credentials of a member as well as other data related to banks, finance, transactions and a digital credit card and credentials of a member as well as other data related to banks, finance, transactions and a digital credit module The system processing unit is connected to the one or more analytic databases and the one or more universal databases. Herein the system processing unit executes server-computer-readable instructions to train an artificial intelligence-based personalized assistance model and further executes server computer-readable instructions to automatically managing payments through the digital credit module and performing a plurality of personalized assistance tasks with the help of artificial intelligence-based personalized assistance model. Herein, the system processing unit executes server-computer-readable instructions to manage the credentials of a member as well as other data related to banks, finance, merchants, and the digital credit module. The member-computing device is connected to the system processing unit of the one or more main server computers through a public network communication server. The member-computing device executes member computer-readable instructions to communicate with the system processing unit to perform a digital credit module based payment and a plurality of personalized assistance tasks. The member-computing device includes a display unit and member database. The display unit displays all the data that are being communicated to the member-computing device through the system processing unit of the one or more main server computers. The member database stores credentials of a member as well as other data related to banks, finance, transactions ID, offline payment details and a digital credit module. Herein, the display unit of the member-computing device is the interface between the system processing unit and the member. The one or more merchant computing devices are connected to the system processing unit of the one or more main server computers through a public network communication server. The one or more merchant computing devices execute merchant computer-readable instructions to communicate with the system processing unit to receive payment and purchase order from the member-computing device through the digital credit module. The one or more merchant computing devices include a merchant database. The merchant database stores credentials of a merchant as well as other data related to banks, finance, transactions ID, offline payment details and invoices. The warehouse database is connected to the system processing unit of the one or more main server computers. The unstructured database is connected to the system processing unit of the one or more main server computers. The payment gateway server is connected to the system processing unit of the one or more main server computers and the one or more universal databases, the payment gateway server performs payment and invoice transfer between the one or more merchant computing devices and the member-computing device. In an embodiment, the member-computing device and the one or more merchant computing devices include, but are not limited to, a desktop computer, a laptop, a tab, a smartphone, and a smart watch. In an embodiment, the data for training the artificial intelligence-based personal assistance model are extracted from the one or more universal databases and the member-computing device. In an embodiment, the member-computing device processor performs the automated purchase of goods and services with the help of a trained artificial intelligence-based personal assistance model that learns from the purchase pattern of the member and various other online activities of member. In an embodiment, the artificial intelligence-based personal assistance model is a machine-learning model. In an embodiment, for offline payment transaction between the one or more member computing devices and the one or more merchant computing devices use the merchant wireless unit and member wireless unit that are selected from Near Filed Communication device, Unstructured Supplementary Service Data system, and Bluetooth.

In an embodiment, the present invention a method for artificial intelligence-based digital credit module management and personalized assistance. The method including

A method of member sign up, the method having
a member communicates personal information to a main server computer by using a member-computing device;
a system processing unit of the main server computer stores the personal information into a universal database;
further, the system processing unit generates a unique ID after the user is approved and sends the unique ID to a member on the member-computing device to setup password and security question;
further, all passwords and security questions are displayed on a display unit of the member-computing device and stored in the universal database.

A method of member digital credit module registration, the method having
the member communicates password and OTP to the main server computer by using the member-computing device;
the system processing unit allows the member to login into the main server computer;
the system processing unit executes server computer-readable instructions to calculate the credit risk of the member and displays credit risk on the display unit;
the system processing unit executes server computer-readable instructions to display documents to be uploaded on the universal database based on credit risk; the system processing unit executes server computer-readable instructions to store, personal identification details in an encrypted form and all the documents, into the universal database;
the system processing unit executes server computer-readable instructions and verifies the member income, spending behaviour, transactions, debts, repayment history, credit risk profile;
in case of missing information, a message is displayed on the display unit;
in case, documents verification is successful, using the prebuilt logic, the system processing unit calculates the member credit limit and stores in the universal database;
the system processing unit generates the membership ID if the credit limit is greater than zero;
with the help of the member-computing device, the member selects the repayment cycle and the same is stored in the universal database; the member updates family member details and the member-computing device details, the same is stored in the universal database; and the system processing unit generates an Email/SMS with the link to download the artificial intelligence-based digital credit module on the member-computing device;
thus, a member now uses an artificial intelligence-based digital credit module to purchase goods and services.

A method of creating artificial intelligence-based personal assistance models, the method having
the system processing unit retrieves all type of information about the member from the universal database, the member-computing device through the extract, transform and load method;
the system processing unit stores all type of retrieved information into the analytic database;
the system processing unit stores the referential dataset into the warehouse database;
the system processing unit stores unstructured data from the member-computing device into an unstructured database;
the system processing unit takes all the data from an analytic database, a warehouse database, and an unstructured database;
further, the system processing unit executes server computer-readable instructions to synthesize data, find data with missing values and apply imputation on data with missing values;
the system processing unit executes server computer-readable instructions to identify outlier data and removed same;
the system processing unit executes server computer-readable instructions to categorized data on the different category;
the system processing unit executes server computer-readable instructions to apply encoding to categorical data;
the system processing unit executes server computer-readable instructions to scale data using normalization and standardization;
the system processing unit further feed data into the artificial intelligence-based personal assistance model and train the artificial intelligence-based personal assistance model.
Herein, the artificial intelligence-based personal assistance model is being used by the system processing unit to automatically send timely alerts, notification, digital credit module information, and provides personal assistance to members based on learning from members purchasing behaviour and other activities.

A method of purchasing essentials using the digital credit module and the artificial intelligence-based personal assistance models, the method having based on purchasing pattern and consumption rate the artificial intelligence-based personal assistance models populate a list of items on the display unit of the member-computing device;
member review the list and edits the list in case required and further confirms the items to be purchased, then the artificial intelligence-based personal assistance model checks credit limit of the digital credit module;
in case, the credit is available then the artificial intelligence-based personal assistance model directs to place an order, and stores the purchase data in the universal database;
the artificial intelligence-based personal assistance model creates transaction ID and sends transaction ID to a payment gateway server and stores the created transaction ID in the universal database;
a payment gateway server generates an order ID and sends the order ID to the merchant on a merchant computing device;
the merchant generates an invoice on the merchant computing device and sends the invoice to the system processing unit that further sent to the member-computing device;
the member check the invoice and confirms, then artificial intelligence-based personal assistance models initiate payment through the digital credit module; the payment gateway server received payment request and the payment gateway server sends payment to the merchant account;
on receiving payment merchant delivers the order and the artificial intelligence-based personal assistance models update the credit limit in the universal database;
in case the payment is not received by, the merchant then the artificial intelligence-based personal assistance, models update the credit limit in the universal database and merchant do not deliver the order;
in another case, an order is canceled and the payment gateway server makes a refund then the artificial intelligence-based personal assistance model updates the credit limit in the universal database.

A method for on-spot purchasing assistant using the artificial intelligence-based personal assistance model and the digital credit module, the method having the artificial intelligence-based personal assistance model sends a notification to a member on the member-computing device, based on member preferences and geo-location;
then member enters store based on offers notification received on the member-computing device;
members select item and go to counter for billing and payment;
the merchant generates the invoice and sends to the member-computing device through the payment gateway server;
member confirm the invoice, the artificial intelligence-based personal assistance model checks the credit limit of the digital credit module; in case, the credit is available then the artificial intelligence-based personal assistance models to proceed for payment;
the member initiates payment through the digital credit module;
the payment gateway server received payment request and the payment gateway server's ends payment to the merchant account;
on receiving payment merchant delivers the order;
once payment is received by the merchant then the artificial intelligence-based personal assistance model updates the credit limit in the universal database.

In the preferred embodiment, the artificial intelligence-based personal assistance model sends a notification to the member, when the member is in a shopping mall and arcade, and when the member is in a particular store.

In an embodiment, the artificial intelligence-based personal assistance model is used by the system processing unit to execute the different task for a member, the task includes:
the artificial intelligence-based personal assistance model reminds member for payment of credit bill and Prompt member for repayment before/by the due date;
the artificial intelligence-based personal assistance model reminds member for rent payment, loan EMI instalment before/by the due date;
the artificial intelligence-based personal assistance model proposes healthy alternatives based on food consumption habits of the member and health data while placing grocery or food orders;
the artificial intelligence-based personal assistance model reminds member for vehicle insurance renewal and vehicle routine servicing;
the artificial intelligence-based personal assistance model also gather data related to the members hobbies and interest, and notify the member about any sports game/event related to members hobbies and interest and even book tickets for the same once user confirms;
the artificial intelligence-based personal assistance model also note special event in member life on the calendar and notify a user of the same and further make purchases and booking accordingly;
based on monthly daily consumption, the artificial intelligence-based personal assistance model notify the member with a list of grocery items that need to be purchase before the due date, and when once the member confirms the list of grocery items then the artificial intelligence-based personal assistance model automatically place an order for grocery items and make payments from digital credit module;
the artificial intelligence-based personal assistance model propose booking of Ticket based on travel plan calendar;
the artificial intelligence-based personal assistance model also arranging a cab based on a calendar event by looking at the time of the meeting, travel distance, and traffic condition.

In an embodiment, the artificial intelligence-based personal assistance model proposes booking train for non-urgent travel plan within 500 km distance, booking flights for non-urgent travel plan with a distance of more than 500 km, and booking flights even for less than 500 km distance but travel is urgently required.

In an embodiment, the member manages different data related to the member in the universal database including but is not limited to, changing picture, automating repayment of credit, edits the personal information of the member, edits important days in member life, edits preferences and dislikes, manage/view credit bills, view real-time account status, view spending behavior of member, update auto-pay set-up for utility.

In an embodiment, the artificial intelligence-based personal assistance model also provides support to a member by executing the self-diagnosis method, the method includes:
the artificial intelligence-based personal assistance model regularly self-diagnose the system of the present invention and look for the issue;
in case the artificial intelligence-based personal assistance model identifies the issues during the transactions, then execute best actions to resolve the issue;
in case issues are not resolved then transfer the query to the support engineer.

In an embodiment, the member and merchant are able to execute offline transaction, the method includes
a method of offline transaction between member and merchant, the method having
   the member completes the shopping and goes to counter for billing and payment,
   the merchant logged into the merchant computing device, in case, there is no network, then the merchant computing device displays product list and price that is stored in the merchant database, the merchant prepares offline invoice and then the merchant computing device generates the transaction ID that are stored in in the merchant database,
   the merchant computing device collects the Member details from the member computing device through merchant wireless unit, then the merchant computing device generates offline invoice, then the merchant computing device sends the offline invoice to the member computing device with help of a merchant wireless unit,
   the merchant computing device also sends transaction ID and offline invoice details to a payment gateway server through the merchant wireless unit, the member logged into the member computing device
   the offline invoice details are received by the member computing device through a member wireless unit, then, the member computing device stores offline invoice detail in a member database,
   member confirm payment of offline invoice through the member computing device,
   in case, the credit limit is less than offline invoice amount then the member computing device check if the invoice amount less than the offline payment limit and update same on member database,
   in case, invoice amount less than the offline payment limit then the member computing device generates transaction ID that is stored in the member database,
   then the member computing device sends the offline payment details to payment gateway server through member wireless unit,
   then the member computing device updates the credit limit and offline payment limit and stores in the member database; and
   simultaneously, the member computing device sends the offline payment details to the merchant computing device through the member wireless unit then again the merchant computing device update offline payment details against the offline invoice and sends updates of the offline payment received details to payment gateway server through the merchant wireless unit, the payment gateway server received the offline payment received details and stored the same,
   on receiving payment merchant delivers the order, and

a method of offline payment details synchronization with online payment data, the method having
the merchant logged into the merchant computing device and check if the merchant computing device gets online and connected to an universal database,
when the merchant computing device gets online, then triggers to synchronize offline transactions,
if there is any conflict with online transactions, the merchant computing device decides which transactions will have priority based on the defined conflict rules,
the merchant computing device extract the offline invoices details and offline payment details from the merchant database,
then the merchant computing device generates the detailed offline invoice and offline payment details and sends to the payment gateway server,
the merchant computing device also sends, the detailed offline invoice and offline payment details, to the universal database to be stored in the universal database,
when member logged into the member computing device then gets notification from the payment gateway server to synchronize offline transactions,
the payment gateway server sends the detailed offline invoice to the universal database that is accessed by the member computing device, the member computing device synchronizes the offline payment and offline invoice details,
if there is any conflict with online transactions, the member computing device decides which transactions will have priority based on the defined conflict rules,
the member computing device again extracts the offline invoices and offline payment details that is stored in the member database and sends to be stored in the universal database,
and the member computing device sends synchronized offline payment and offline invoice details to the payment gateway server from the member database,
a system processing unit update the credit limit and offline payment limit in the universal database;
simultaneously, the payment gateway server executes online payment and sends payment details to the merchant computing device and the merchant computing device update payment receiving details in the universal database and the merchant database.

In an embodiment, the merchant wireless unit and member wireless unit are selected from Near Filed Communication device, Unstructured Supplementary Service Data system, and Bluetooth.

In an embodiment, the present invention is a method for artificial intelligence-based digital credit module management and personalized assistance. The method including

A method of member sign up, the method having
a member communicates personal information to one or more main server computers by using a member-computing device;
a system processing unit of the one or more main server computers stores the personal information into one or more universal databases;
further, the system processing unit generates a unique ID after the user is approved and sends the unique ID to the member on the member-computing device to setup password and security question;
further, all password and security questions are displayed on a display unit of the member-computing device and stored in the one or more universal databases.

A method of member digital credit module registration, the method having
the member communicates password and OTP to the one or more main server computers by using the member-computing device;
the system processing unit allows the member to log in into the one or more main server computers;
the system processing unit executes server computer-readable instructions to calculate the credit risk of the member display credit risk on the display unit;
the system processing unit executes server computer-readable instructions to display documents to be uploaded on the one or more universal databases based on credit risk;
the system processing unit executes server computer-readable instructions to store, personal identification details in an encrypted form and all the documents, into the one or more universal databases;
the system processing unit executes server computer-readable instructions and verifies the member income, spending behavior, transactions, debts, repayment history, credit risk profile;
in case of missing information, a message is displayed on the display unit; in case, documents verification is successful, using the prebuilt logic, the system processing unit calculates the member credit limit and stores in the one or more universal databases;
the system processing unit generates the membership ID if the credit limit is greater than zero;
with the help of the member-computing device, the member selects the repayment cycle and the same is stored in the one or more universal databases; the member updates family member details and the member-computing device details, the same is stored in the one or more universal databases; and
the system processing unit generates an Email/SMS with the link to download the artificial intelligence-based digital credit module on the member-computing device;
thus, a member now uses the artificial intelligence-based digital credit module to purchase goods and services.

A method of creating an artificial intelligence-based personal assistance model, the method having
the system processing unit retrieves all type of information about the member from the one or more universal databases, the member-computing device through the extract, transform and load method;
the system processing unit stores all type of retrieved information into the one or more analytic databases;
the system processing unit stores the referential dataset into the warehouse database;
the system processing unit stores unstructured data from the member-computing device into an unstructured database;
the system processing unit takes all the data from one or more analytic databases, the warehouse database, and unstructured database;
further, the system processing unit executes server computer-readable instructions to synthesize data, find data with missing values and apply imputation on data with missing values;
the system processing unit executes server computer-readable instructions to Identify outlier data and removed the same;
the system processing unit executes server computer-readable instructions to categorized data on the different category
the system processing unit executes server computer-readable instructions to apply encoding to categorical data
the system processing unit executes server computer-readable instructions to scale data using normalization and standardization.
the system processing unit further feed data into the artificial intelligence-based personal assistance model and train the artificial intelligence-based personal assistance model; and
wherein, the artificial intelligence-based personal assistance model is being used by the system processing unit to automatically send timely alerts, notification, digital credit module information, and provides personal assistance to member based on learning from members purchasing behavior and other activities.

A method of purchasing essentials using the digital credit module and the artificial intelligence-based personal assistance models, the method having
based on purchasing pattern and consumption rate the artificial intelligence-based personal assistance models populate a list of items on the display unit of the member-computing device;
member review the list and edits the list in case required and further confirms the items to be purchased, then the artificial intelligence-based personal assistance model checks credit limit of the digital credit module;
in case, the credit is available then the artificial intelligence-based personal assistance model directs to place an order, and stores the purchase data in the one or more universal databases;
the artificial intelligence-based personal assistance model creates transaction ID and sends transaction ID to a payment gateway server and also stores the creates transaction ID in the one or more universal databases;
payment gateway server generates an order ID and sends the order ID to the merchant on one or more merchant computing devices;
the merchant generates an invoice on the one or more merchant computing devices and sends the invoice to the system processing unit that further sent to the member-computing device;
the member check the invoice and confirms, then artificial intelligence-based personal assistance models initiate payment through the digital credit module; the payment gateway server received payment request and the payment gateway server's ends payment to the merchant account;
on receiving payment merchant delivers the order and the artificial intelligence-based personal assistance models update the credit limit in the one or more universal databases;
in case the payment is not received by the merchant then the artificial intelligence-based personal assistance models update the credit limit in the one or more universal databases and merchant do not deliver order;
in another case, an order is canceled and the payment gateway server makes a refund then the artificial intelligence-based personal assistance model updates the credit limit in the one or more universal databases.

A method for on-spot purchasing assistant using the artificial intelligence-based personal assistance models and the digital credit module, the method having
the artificial intelligence-based personal assistance model sends a notification to a member on the member-computing device, based on member preferences and geo-location;
then member enters store based on offers notification received on the member-computing device;
members select item and go to counter for billing and payment;
the merchant generates the invoice and sends the invoice to the member-computing device through the payment gateway server;
member confirm the invoice, the artificial intelligence-based personal assistance model checks the credit limit of the digital credit module;
in case, the credit is available then the artificial intelligence-based personal assistance models to proceed for payment;
the member initiates payment through the digital credit module;
the payment gateway server received payment request and the payment gateway server sends payment to the merchant account;
on receiving payment merchant delivers the order;
once payment is received by the merchant then the artificial intelligence-based personal assistance model updates the credit limit in one or more universal databases.

In the preferred embodiment, the artificial intelligence-based personal assistance model sends a notification to the member, when the member is in a shopping mall and arcade, and when the member is in a particular store.

In an embodiment, the artificial intelligence-based personal assistance model is used by the system processing unit to execute the different task for a member, the task includes:
the artificial intelligence-based personal assistance model reminds member for payment of credit bill and Prompt member for repayment before/by the due date;
the artificial intelligence-based personal assistance model reminds member of rent payment, loan EMI installment before/by the due date;
the artificial intelligence-based personal assistance model proposes healthy alternatives based on food consumption habits of the member and health data while placing grocery or food orders;
the artificial intelligence-based personal assistance model reminds member of vehicle insurance renewal and vehicle routine servicing;
the artificial intelligence-based personal assistance model also gather data related to the member's hobbies and interest, and notify the member about any sports game/event related to members hobbies and interest and even book tickets for the same once user confirms;
the artificial intelligence-based personal assistance model also note special event in member life on the calendar and notify the user of the same and further make purchases and booking accordingly;
based on monthly daily consumption, the artificial intelligence-based personal assistance model notify the member with a list of grocery items that need to be purchase before the due date, and when once the member confirms the list of grocery items then the artificial intelligence-based personal assistance model automatically place an order for grocery items and make payments from digital credit module;
the artificial intelligence-based personal assistance model propose booking of Ticket based on travel plan calendar;
the artificial intelligence-based personal assistance model also arranging a cab based on a calendar event by looking at the time of the meeting, travel distance, and traffic condition.

In an embodiment, the artificial intelligence-based personal assistance model proposes booking train for non-urgent travel plan within 500 km distance, booking flights for non-urgent travel plan with a distance of more than 500 km, and booking flights even for less than 500 km distance but travel is urgently required.

In an embodiment, a member is able to manage different data related to the member in the one or more universal databases including but is not limited to, changing picture, automating repayment of credit, edits the personal information of the member, edits important days in member life, edits preferences and dislikes, manage/view credit bills, view real-time account status, view spending behavior of member, update auto-pay set-up for utility.

In an embodiment, the artificial intelligence-based personal assistance model also provides support to the member by executing the self-diagnosis method, the method includes:
the artificial intelligence-based personal assistance model regularly self-diagnose the system of the present invention and look for the issue;
in case the artificial intelligence-based personal assistance model identifies the issues during the transactions, then execute best actions to resolve the issue;
in case issues are not resolved then transfer the query to the support engineer.

In an embodiment, the member and merchant are able to execute offline transaction, the method includes
a method of offline transaction between member and merchant, the method having the member completes the shopping and goes to counter for billing and payment,
the merchant logged into the one or more merchant computing devices, in case, there is no network, then the one or more merchant computing devices display product list and price that is stored in the merchant database, the merchant prepares offline invoice and then the one or more merchant computing devices generate the transaction ID that are stored in in the merchant database,
the one or more merchant computing devices collect the Member details from the one or more member computing devices through merchant wireless unit,
then the one or more merchant computing devices generates offline invoice, then the one or more merchant computing devices sends the offline invoice to the one or more member computing devices with help of a merchant wireless unit,
the one or more merchant computing devices also send transaction ID and offline invoice details to a payment gateway server through the merchant wireless unit,
the member logged into the one or more member computing devices the offline invoice details are received by the one or more member computing devices through a member wireless unit, then, the one or more member computing devices stores offline invoice detail in a member database,
member confirm payment of offline invoice through the one or more member computing devices,
in case, the credit limit is less than offline invoice amount then the one or more member computing devices check if the invoice amount less than the offline payment limit and update same on member database,
in case, invoice amount less than the offline payment limit then the one or more member computing devices generates transaction ID that is stored in the member database,
then the one or more member computing devices send the offline payment details to payment gateway server through member wireless unit, then the one or more member computing devices update the credit limit and offline payment limit and stores in the member database; and simultaneously, the one or more member computing devices send the offline payment details to the one or more merchant computing devices through the member wireless unit
then again the one or more merchant computing devices update offline payment details against the offline invoice and sends updates of the offline payment received details to payment gateway server through the merchant wireless unit,
the payment gateway server received the offline payment received details and stored the same,
on receiving payment merchant delivers the order, and

a method of offline payment details synchronization with online payment data, the method having
the merchant logged into the one or more merchant computing devices and check if the one or more merchant computing devices gets online and connected to an one or more universal databases,
when the one or more merchant computing devices get online, then triggers to synchronize offline transactions,
if there is any conflict with online transactions, the one or more merchant computing devices decide which transactions will have priority based on the defined conflict rules,
the one or more merchant computing devices extract the offline invoices details and offline payment details from the merchant database, then the one or more merchant computing devices generate the detailed offline invoice and offline payment details and sends to the payment gateway server,
the one or more merchant computing devices also send, the detailed offline invoice and offline payment details, to the one or more universal databases to be stored in the one or more universal databases,
when member logged into the one or more member computing devices then gets notification from the payment gateway server to synchronize offline transactions,
the payment gateway server sends the detailed offline invoice to the one or more universal databases that is accessed by the one or more member computing devices,
the one or more member computing devices synchronize the offline payment and offline invoice details,
if there is any conflict with online transactions, the one or more member computing devices decide which transactions will have priority based on the defined conflict rules,
the one or more member computing devices again extract the offline invoices and offline payment details that is stored in the member database and sends to be stored in the one or more universal databases,
and the one or more member computing devices send synchronized offline payment and offline invoice details to the payment gateway server from the member database,
a system processing unit update the credit limit and offline payment limit in the one or more universal databases;
simultaneously, the payment gateway server executes online payment and sends payment details to the one or more merchant computing devices and the one or more merchant computing devices update payment receiving details in the one or more universal databases and the merchant database.

In an embodiment, the merchant wireless unit and member wireless unit are selected from Near Filed Communication device, Unstructured Supplementary Service Data system, and Bluetooth.

In an embodiment, the member and merchant are able to execute offline transaction, the method includes

a method of offline transaction between member and merchant, the method having
the member completes the shopping and goes to counter for billing and payment,
the merchant logged into the one or more merchant computing devices, in case, there is no network, then the one or more merchant computing devices display product list and price that is stored in the merchant database, the merchant prepares offline invoice and then the one or more merchant computing devices generate the transaction ID that are stored in in the merchant database,
the one or more merchant computing devices collect the Member details from the one or more member computing devices through merchant wireless unit,
then the one or more merchant computing devices generates offline invoice, then the one or more merchant computing devices sends the offline invoice to the one or more member computing devices with help of a merchant wireless unit,
the one or more merchant computing devices also send transaction ID and offline invoice details to a payment gateway server through the merchant wireless unit,
the member logged into the one or more member computing devices the offline invoice details are received by the one or more member computing devices through a member wireless unit, then, the one or more member computing devices stores offline invoice detail in a member database,
member confirm payment of offline invoice through the one or more member computing devices,
in case, the credit limit is less than offline invoice amount then the one or more member computing devices check if the invoice amount less than the offline payment limit and update same on member database,
in case, invoice amount less than the offline payment limit then the one or more member computing devices generates transaction ID that is stored in the member database,
then the one or more member computing devices send the offline payment details to payment gateway server through member wireless unit, then the one or more member computing devices update the credit limit and offline payment limit and stores in the member database; and
simultaneously, the one or more member computing devices send the offline payment details to the one or more merchant computing devices through the member wireless unit
then again the one or more merchant computing devices update offline payment details against the offline invoice and sends updates of the offline payment received details to payment gateway server through the merchant wireless unit,
the payment gateway server received the offline payment received details and stored the same,
on receiving payment merchant delivers the order, and

a method of offline payment details synchronization with online payment data, the method having
the merchant logged into the one or more merchant computing devices and check if the one or more merchant computing devices gets online and connected to an one or more universal databases,
when the one or more merchant computing devices get online, then triggers to synchronize offline transactions,
if there is any conflict with online transactions, the one or more merchant computing devices decide which transactions will have priority based on the defined conflict rules,
the one or more merchant computing devices extract the offline invoices details and offline payment details from the merchant database, then the one or more merchant computing devices generate the detailed offline invoice and offline payment details and sends to the payment gateway server,
the one or more merchant computing devices also send, the detailed offline invoice and offline payment details, to the one or more universal databases to be stored in the one or more universal databases,
when member logged into the one or more member computing devices then gets notification from the payment gateway server to synchronize offline transactions,
the payment gateway server sends the detailed offline invoice to the one or more universal databases that is accessed by the one or more member computing devices,
the one or more member computing devices synchronize the offline payment and offline invoice details,
if there is any conflict with online transactions, the one or more member computing devices decide which transactions will have priority based on the defined conflict rules,
the one or more member computing devices again extract the offline invoices and offline payment details that is stored in the member database and sends to be stored in the one or more universal databases,
and the one or more member computing devices send synchronized offline payment and offline invoice details to the payment gateway server from the member database,
a system processing unit update the credit limit and offline payment limit in the one or more universal databases;
simultaneously, the payment gateway server executes online payment and sends payment details to the one or more merchant computing devices and the one or more merchant computing devices update payment receiving details in the one or more universal databases and the merchant database.

In an embodiment, the merchant wireless unit and member wireless unit are selected from Near Filed Communication device, Unstructured Supplementary Service Data system, and Bluetooth.

In yet another embodiment, the member-computing device receives health data from external health monitoring devices further send to the system processing unit. The artificial intelligence-based personal assistance model uses the health data the member to suggest healthy lifestyle, and foods. The artificial intelligence-based personal assistance model uses the health data to predict any health emergency related to the member.

In yet another embodiment, the member-computing device directly receives an invoice from the merchant device while purchasing the goods on the spot from the merchant's physical shop. Further, the artificial intelligence-based personal assistance model automatically makes payment to the merchant with the help of a payment gateway server.

In yet another embodiment, the member allocates supplementary credit limits for their family member and generates a supplementary membership ID of a family member. Further, the member transfers a few percentages of credit limits of the digital credit module to the supplementary membership ID of their family member. The family member registers their device unique ID with the digital credit module and further family member spend with help of the digital credit module. Thus, further, the supplementary credit limit of a family member and credit limit of the member is updated in the database. The member is also able to view spending behavior of their family member.

In yet another embodiment, the member also allocates a certain available credit limit to their children as pocket money with the option of restricting spending on categories. the member allocates pocket money credit limit for their children and generates supplementary child membership ID of their children. Further, the member transfers a few percentages of credit limits of the digital credit module to the supplementary child membership ID of their children. The children register their device unique ID with the digital credit module and further spend with help of the digital credit module. Thus, further, the pocket money credit limit of the children and the credit limit of the member is updated in the database. The member also restricts the category of product and service that is allowed to be purchased by the children.

Further objectives, advantages, and features of the present invention will become apparent from the detailed description provided herein below, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim:

1. A system(100) and method for artificial intelligence-based digital credit module and personalized assistance, the system(100) comprising:
an at least one analytic database(108), the at least one analytic database(108) stores artificial intelligence-based personal assistance models and data for training an artificial intelligence-based personal assistance models;
an at least one universal database(118), the at least one universal database(118) stores the credentials of a member and merchant, and as well as other data related to banks, finance, transactions ID, offline payment details, merchants, and a digital credit module;
an at least one main server computer(102), the at least one main server computer(102) having
an at least one server computer memory(104), the at least one server computer memory(104) stores server computer-readable instructions and credentials of a member as well as other data related to banks, finance, transactions and a digital credit module and
a system processing unit(106), the system processing unit(106) is connected to the at least one analytic database(108) and the at least one universal database(114), wherein the system processing unit(106) executes server-computer-readable instructions to train an artificial intelligence-based personalized assistance model and further executes server computer-readable instructions to automatically managing payments through the digital credit module and performing a plurality of personalized assistance tasks with the help of artificial intelligence-based personalized assistance model, wherein, the system processing unit(106) executes server-computer-readable instructions to manage credentials of a member as well as other data related to banks, finance, merchants and a digital credit module;
a member-computing device(110), the member-computing device(110) is connected to the system processing unit(106) of the at least one main server computer(102) through a public network communication server, the member-computing device(110) executes member computer-readable instructions to communicate with the system processing unit(106) to perform digital credit module based payment and a plurality of personalized assistance tasks, and the member-computing device(110) having
a display unit(112), the display unit(112) displays all the data that is being communicated to the member-computing device(110) through the system processing unit(106) of the at least one main server computer(102), wherein, the display unit(112) of the member-computing device(110) is the interface between the system processing unit(106) and member, and
a member database(204), the member database(204) stores credentials of a member as well as other data related to banks, finance, transactions ID, offline payment details and a digital credit module;
an at least one merchant computing device(122), the at least one merchant computing device(122) is connected to the system processing unit(106) of the at least one main server computer(102) through a public network communication server, the at least one merchant computing device(122) executes merchant computer-readable instructions to communicate with the system processing unit(106) to receive payment and purchase order from the member-computing device(110) through the digital credit module the at least one merchant computing device(122) having
a merchant database(206), the merchant database(206) stores credentials of a merchant as well as other data related to banks, finance, transactions ID, offline payment details and invoices;
a warehouse database(114), the warehouse database(114) is connected to the system processing unit(106) of the at least one main server computer(102);
an unstructured database(116), the unstructured database(116) is connected to the system processing unit(106) of the at least one main server computer(102);
a payment gateway server(120), the payment gateway server(120) is connected to the system processing unit(106) of the at least one main server computer(102), the at least one universal database(118), the at least one merchant computing device(122) and the at least one member computing device(110) the payment gateway server(120) performs payment and invoice transfer between the at least one merchant computing device(122) and the member-computing device(110).

2. The system(100) as claimed in claim 1, wherein the member-computing device(110) and between the at least one merchant computing device(122) are selected from a desktop computer, a laptop, a tab, a smartphone and, a smart watch.

3. The system(100) as claimed in claim 1, wherein the data for training the artificial intelligence-based personal assistance model has extracted from the at least one universal database(118) and the member-computing device(110).

4. The system(100) as claimed in claim 1, wherein, the member-computing device processor(116) performs the automated purchase of goods and services with the help of a trained artificial intelligence-based personal assistance model that learns from the purchase pattern of the member and various other online activities of member.

5. The system(100) as claimed in claim 1, wherein, artificial intelligence-based personal assistance models is a machine-learning model.

6. The system(100) as claimed in claim 1, wherein, for offline payment transaction between the at least one member computing device(110) and the at least one merchant computing device(122) uses the merchant wireless unit(208) and member wireless unit(210) that are selected from Near Filed Communication device, Unstructured Supplementary Service Data system, and Bluetooth.

7. A method for artificial intelligence-based digital credit module management and personalized assistance, the method comprising:
a method of member sign up, the method having
a member communicates personal information to an at least one main server computer(102) by using a member-computing device(110),
a system processing unit(106) of the at least one main server computer(102) stores the personal information into an at least one universal database(118), further, the system processing unit generates a unique ID after the user is approved and sends the unique ID to member the member-computing device(110) to setup password and security question,
further, all password and security questions are displayed on a display unit(112) of the member-computing device(110) and stored in the at least one universal database(118);
a method of member digital credit module registration, the method having
the member communicates password and OTP to the at least one main server computer(102) by using the member-computing device(110),
the system processing unit(106) allows the member to login into the at least one main server computer(102),
the system processing unit(106) executes server computer-readable instructions to calculate the credit risk of the member display credit risk on the display unit(112),
the system processing unit(106) executes server computer-readable instructions to display documents to be uploaded on the at least one universal database(118) based on credit risk,
the system processing unit(106) executes server computer-readable instructions to store, personal identification details in an encrypted form and all the documents, into the at least one universal database(118),
the system processing unit(106) executes server computer-readable instructions and verifies the Member Income, spending behavior, transactions, debts, repayment history, credit risk profile,
in case of missing information, a message is displayed on the display unit(112),
in case, documents verification is successful, using the prebuilt logic, the system processing unit(106) calculates the member credit limit and stores in the at least one universal database(118),
the system processing unit(106) generates the membership ID if the credit limit is greater than zero,
with the help of the member-computing device(110), the member selects the Repayment cycle and the same is stored in the at least one universal database(118),
the member updates family member details and the member-computing device(110) details, the same is stored in the at least one universal database(118),
the system processing unit(106) generates an Email/SMS with the link to download the artificial intelligence-based digital credit module on the member-computing device(110), and
thus, a member now uses the artificial intelligence-based digital credit module to purchase goods and services;
a method of creating an artificial intelligence-based personal assistance model, the method having
the system processing unit(106) retrieves all type of information about the member from the at least one universal database(118), the member-computing device(110) through the extract, transform and load method,
the system processing unit(106) stores all type of retrieved information into the at least one analytic database(108),
the system processing unit(106) stores the referential dataset into the warehouse database (114),
the system processing unit(106) stores unstructured data from the member-computing device(110) into an unstructured database(116),
the system processing unit(106) takes all the data from the at least one analytic database(108), the warehouse database (114), and unstructured database(116),
further, the system processing unit(106) executes server computer-readable instructions to synthesize data, find data with missing values and apply imputation on data with missing values,
the system processing unit(106) executes server computer-readable instructions to identify outlier data and removed same,
the system processing unit(106) executes server computer-readable instructions to categorized data on the different category,
the system processing unit(106) executes server computer-readable instructions to apply encoding to categorical data
the system processing unit(106) executes server computer-readable instructions to scale data using normalization and standardization.
the system processing unit(106) further feed data into the artificial intelligence-based personal assistance model and train the artificial intelligence-based personal assistance model;
wherein, the artificial intelligence-based personal assistance model is being used by the system processing unit(106) to automatically sends timely alerts, notification, digital credit module information, and also provides personal assistance to member based on learning from members purchasing behavior and other activities;
a method of purchasing essentials using the digital credit module and the artificial intelligence-based personal assistance model, the method having
based on purchasing pattern and consumption rate the artificial intelligence-based personal assistance models populate a list of items on the display unit(112) of the member-computing device(110),
member review the list and edits the list in case required and further confirms the items to be purchased, then the artificial intelligence-based personal assistance model checks credit limit of the digital credit module, in case, the credit is available then the artificial intelligence-based personal assistance model directs to place an order, and also stores the purchase data in the at least one universal database(118),
the artificial intelligence-based personal assistance model creates transaction ID and sends transaction ID to a payment gateway server(120) and also stores the creates transaction ID in the at least one universal database(118),
payment gateway server(120) generates an order ID and sends the order ID to the merchant on an at least one merchant computing device(122),
the merchant generates an invoice on the at least one merchant computing device(122) and sends to the system processing unit(106) that further sent to the member-computing device(110),
the member check the invoice and confirms, then artificial intelligence-based personal assistance models initiate payment through the digital credit module,
the payment gateway server(120) received payment request and the payment gateway server(120) sends payment to the merchant account,
on receiving payment merchant delivers the order and the artificial intelligence-based personal assistance models update the credit limit in the at least one universal database(118),
in case the payment is not received by the merchant then the artificial intelligence-based personal assistance models update the credit limit in the at least one universal database(118) and merchant do not deliver order,
in another case, an order is canceled and the payment gateway server(120) make a refund then the artificial intelligence-based personal assistance models update the credit limit in the at least one universal database(118);
a method for on-spot purchasing assistant using the artificial intelligence-based personal assistance model and the digital credit module, the method having
the artificial intelligence-based personal assistance model sends a notification to a member on the member-computing device(110), based on member preferences and geo-location,
then member enters store based on offers notification received on the member-computing device(110),
members select item and go to counter for billing and payment,
the merchant generates the invoice and sends the invoice to the member-computing device(110) through the payment gateway server(120),
member confirm the invoice, the artificial intelligence-based personal assistance model checks the credit limit of the digital credit module,
in case, the credit is available then the artificial intelligence-based personal assistance models to proceed for payment,
the member initiates payment through the digital credit module,
the payment gateway server(120) received payment request and the payment gateway server(120) sends payment to the merchant account,
on receiving payment merchant delivers the order, and
once payment is received by the merchant then the artificial intelligence-based personal assistance models update the credit limit in the at least one universal database(118);
the artificial intelligence-based personal assistance model is being used by the system processing unit(106) to executes different task for a member, the task having:
the artificial intelligence-based personal assistance model reminds member for payment of credit bill and Prompt member for repayment before/by the due date;
the artificial intelligence-based personal assistance model reminds member of rent payment, loan EMI installment before/by the due date,
the artificial intelligence-based personal assistance model proposes healthy alternatives based on food consumption habits of the member and health data while placing grocery or food orders,
the artificial intelligence-based personal assistance model reminds member of vehicle insurance renewal and vehicle routine servicing,
the artificial intelligence-based personal assistance model also gather data related to the member's hobbies and interest, and notify the member about any sports game/event related to members hobbies and interest and even book tickets for the same once user confirms,
the artificial intelligence-based personal assistance model also note special event in member life on the calendar and notify a user of the same and further make purchases and booking accordingly,
based on monthly daily consumption, the artificial intelligence-based personal assistance model notify the member with a list of grocery items that need to be purchase before the due date, and when once the member confirms the list of grocery items then the artificial intelligence-based personal assistance model automatically place an order for grocery items and make payments from digital credit module,
the artificial intelligence-based personal assistance model propose booking of Ticket based on travel plan calendar,
the artificial intelligence-based personal assistance model also arranging a cab based on a calendar event by looking at the time of the meeting, travel distance, and traffic condition.
wherein, the artificial intelligence-based personal assistance model sends a notification to the member, when the member is in a shopping mall and arcade, and when the member is in a particular store.

8. The method as claimed in claim 7, wherein member is able to manage different data related to the member in the at least one universal database(118) selected from changing picture, manage bank account details, automating repayment of credit, setting up offline payment maximum limit for member, update security data, manage the personal information of the member, manage important days in member life, manage preferences and dislikes, manage/view credit bills, view real-time account status, view spending behavior of member, execute online, update auto-pay set-up for utility.

9. The method as claimed in claim 7, wherein, the artificial intelligence-based personal assistance model also provides support to a member by executing self-diagnosis method, the method comprising:
the artificial intelligence-based personal assistance model regularly self-diagnose the system(100) and look for the issue;
in case the artificial intelligence-based personal assistance model identifies the issues during the transactions, then execute best actions to resolve the issue;
in case issues are not resolved then transfer the query to the support engineer.

10. The method as claimed in claim 7, wherein, the member and merchant are able to execute offline transaction, the method comprising:
a method of offline transaction between member and merchant, the method having
In step(212), the member completes the shopping and goes to counter for billing and payment,
In step(214), the merchant logged into the at least one merchant computing device(122),
In step(216), in case, there is no network, then the at least one merchant computing device(122) display product list and price that is stored in the merchant database(206),
In step(218), the merchant prepares offline invoice and then the at least one merchant computing device(122) generates the transaction ID that are stored in in the merchant database(206),
In step(220), the at least one merchant computing device(122) collects the Member details from the at least one member computing device(110) through merchant wireless unit(208),
In step(222), then the at least one merchant computing device(122) generates offline invoice,
In step(224), then the at least one merchant computing device(122) sends the offline invoice to the at least one member computing device(110) with help of a merchant wireless unit(208),
In step(226), the at least one merchant computing device(122) also sends transaction ID and offline invoice details to a payment gateway server(120) through the merchant wireless unit(208),
In step(228), the member logged into the at least one member computing device(110)
In step(230), the offline invoice details are received by the at least one member computing device(110) through a member wireless unit(210), then, the at least one member computing device(110) stores offline invoice detail in a member database(204),
In step(232), member confirm payment of offline invoice through the at least one member computing device(110),
In step(234), in case, the credit limit is less than offline invoice amount then the at least one member computing device(110) check if the invoice amount less than the offline payment limit and update same on member database(204),
In step(236), in case, invoice amount less than the offline payment limit then the at least one member computing device(110) generates transaction ID that is stored in the member database(204),
In step(238), then the at least one member computing device(110) sends the offline payment details to payment gateway server(120) through member wireless unit(210),
In step(240), then the at least one member computing device(110) updates the credit limit and offline payment limit and stores in the member database(204); and
In step(242), simultaneously, the at least one member computing device(110) sends the offline payment details to the at least one merchant computing device(122) through the member wireless unit(210)
In step(244), then again the at least one merchant computing device(122) update offline payment details against the offline invoice and sends updates of the offline payment received details to payment gateway server(120) through the merchant wireless unit(208),
In step(246), the payment gateway server(120) received the offline payment received details and stored the same,
In step(248), on receiving payment merchant delivers the order, and
a method of offline payment details synchronization with online payment data, the method having
In step(250), the merchant logged into the at least one merchant computing device(122) and check if the at least one merchant computing device(122) gets online and connected to an at least one universal database(118),
In step(252), when the at least one merchant computing device(122) gets online, then triggers to synchronize offline transactions,
In step(254), if there is any conflict with online transactions, the at least one merchant computing device(122) decides which transactions will have priority based on the defined conflict rules,
In step(256), the at least one merchant computing device(122) extract the offline invoices details and offline payment details from the merchant database(206),
In step(258), then the at least one merchant computing device(122) generates the detailed offline invoice and offline payment details and sends to the payment gateway server(120),
In step(260), the at least one merchant computing device(122) also sends, the detailed offline invoice and offline payment details, to the at least one universal database(118) to be stored in the at least one universal database(118),
In step(262), when member logged into the at least one member computing device(110) then gets notification from the payment gateway server(120) to synchronize offline transactions,
In step(264), the payment gateway server(120) sends the detailed offline invoice to the at least one universal database(118) that is accessed by the at least one member computing device(110),
In step(266), the at least one member computing device(110) synchronizes the offline payment and offline invoice details,
In step(268), if there is any conflict with online transactions, the at least one member computing device(110) decides which transactions will have priority based on the defined conflict rules,
In step(270), the at least one member computing device(110) again extracts the offline invoices and offline payment details that is stored in the member database(204) and sends to be stored in the at least one universal database(118),
In step(272), and the at least one member computing device(110) sends synchronized offline payment and offline invoice details to the payment gateway server(120) from the member database(204),
In step(274), a system processing unit(106) update the credit limit and offline payment limit in the at least one universal database(118);
In step(276), simultaneously, the payment gateway server(120) executes online payment and sends payment details to the at least one merchant computing device(122) and the at least one merchant computing device(122) update payment receiving details in the at least one universal database(118) and the merchant database(206).
Wherein, the merchant wireless unit(208) and member wireless unit(210) are selected from Near Filed Communication device, Unstructured Supplementary Service Data system, and Bluetooth.
